(19) United States
(12) Patent Application Publication
(10) Pub. No.: US 2007/0090966 A1
(43) Pub. Date: Apr. 26, 2007

(54) Remote control with a barcode reader

(76) Inventors: Hitoshi Watanabe, Saitamai-shi (JP); Hironobu Watanabe, Koshigaya-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/252,136

(22) Filed: Oct. 17, 2005

(51) Int. Cl. G08C 19/00

(52) U.S. Cl. 340/825.69; 235/462.46; 348/732; 725/86; 340/825.72

(57) ABSTRACT

A device for controlling at least one electronic equipment is provided, which comprises a scanner part for reading a barcode representing formation identifying a program processable by the electronic equipment, and a remote control part capable of remotely sending at least one command signal incorporating the information to the electronic equipment so as to instruct the electronic equipment to process the program. Thus, the identification information of the program does not need to be manually input to the remote control, but instead is obtained by reading the barcode by the scanner.

### BACKGROUND OF THE INVENTION

The present invention relates to a remote control for home electronic equipment, and more particularly, to a remote control device having a scanner for reading barcodes identifying programs to be processed by the electronic equipment.

Conventionally, when a user wants to schedule recordation of a program, he or she may key in an identification of the program (such as a VCR Plus number provided on a TV Guide magazine) through the buttons on the remote control, and the input identification is then sent to a VCR by infrared command signals. However, this is inconvenient since the user has to manually input the program identification information (usually a string of numbers) printed on a publication (e.g., the TV Guide magazine) into the remote control. The inconvenience is profound for senior users who do not have good sight to read the small print of the identification numbers.

Therefore, there is a need for a device for conveniently obtaining a program identification and remotely sending it to an electronic equipment capable of processing the program.

### SUMMARY OF THE INVENTION

To realize the above object, a device for controlling at least one piece of electronic equipment is provided, which comprises a scanner for reading a barcode representing information identifying a program processable by the electronic equipment, and a remote control capable of remotely sending at least one command signal incorporating the information to the electronic equipment so as to instruct the electronic equipment to process the program. Thus, the identification information of the program does not need to be manually input to the remote control, but instead is obtained by the scanner.

Preferably, an activation button is provided to trigger the scanner to start a barcode reading operation. Preferably, the identification information obtained by the scanner is automatically sent to the electronic equipment by the remote control.

Preferably, the device is provided with a clip so that the device can be attached to a publication that bears the barcode.

Preferably, the device is provided with a magnet to hold the device on an external subject such as a wall of a refrigerator by a magnetic force.

The electronic equipment may be a TV set, a VCR, or a stereo, and the programs may be on-demand programs, scheduled programs, video programs, audio programs, etc.

Preferably, the identification information may be a VCR Plus number provided on a TV Guide magazine.

### BRIEF EXPLANATIONS OF THE DRAWINGS

The above and other features and advantages will be clearer after reading the detailed description of the preferred embodiments of the present invention with reference to the accompanying drawings, in which:

FIG. 1 is a side view of an embodiment of a remote control device according to the present invention;

FIG. 2 is a top plan view of the embodiment illustrated in FIG. 1;

FIG. 3 schematically illustrates a page of a publication on which the program identifications are present as barcodes.

### DETAILED DESCRIPTION OF THE INVENTION

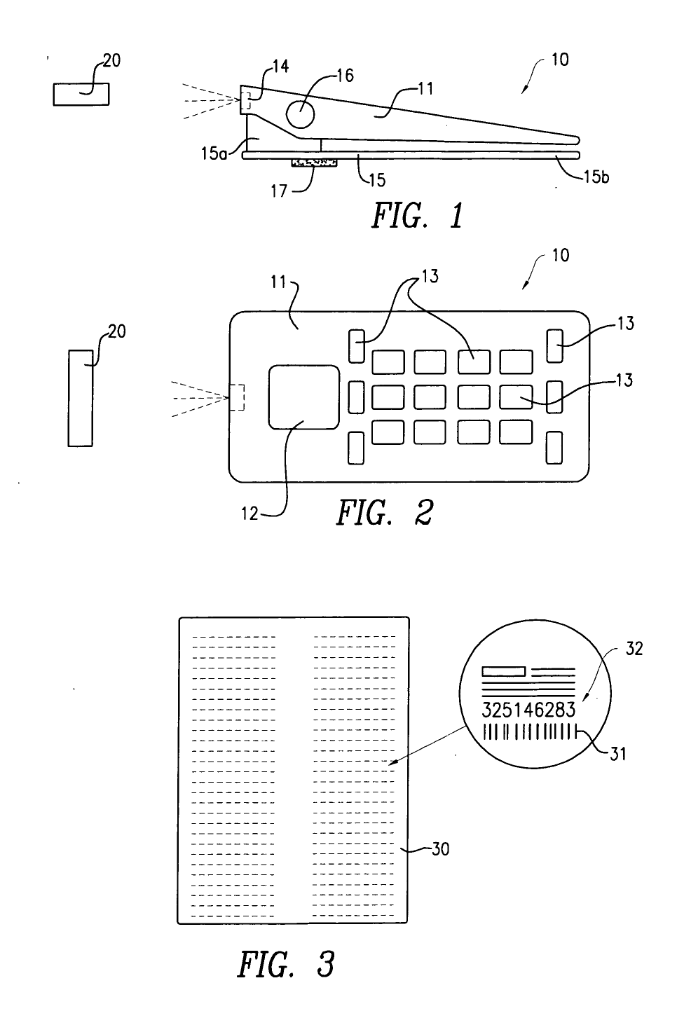

As illustrated in FIGS. 1 and 2, a preferred embodiment of the remote control device 10 according to the present invention is illustrated. Functionally, the device 10 is a combination of a scanner for reading barcodes 31 (see FIG. 3) and a remote control for sending command signals to an electronic equipment 20.

In this embodiment, the device 10 has a generally rectangular body 11 similar to a conventional remote control. Preferably, the device 10 may include conventional functional buttons 13 so that it can also be used as a conventional remote control.

An activation button 12 is provided on the body 11. Pressing the button 12 will trigger the scanner part of the device 10 to start a barcode reading operation so as to obtain the information identifying a specific program as represented by a barcode 31 printed on a page 30 of a publication. For example, the barcode 31 represents a VCR Plus number 32 printed on a TV Guide magazine. Thus, when the activation button 12 is pressed, the scanner part of the device 10 automatically obtains the VCR Plus number 32 encoded in the barcode 31, and the remote control part of the device 10 automatically sends one or more command signals incorporating the decoded VCR Plus number 32 to a VCR 20 so as to schedule recordation. Preferably, the command signals are infrared (IR) signals sent from an emitter 14 provided at a front end of the body 11.

It is advantageous that the identification information obtained by the scanner part of the device 10 is automatically provided to the remote control part, and then the remote control part automatically sends the identification information to the electronic equipment 20 without a further manually operation on the device 10. Thus, with a single pressing on the activation button 12, the barcode 31 is scanned and the decoded identification information is sent to the remote electronic equipment 20.

Preferably, the device 10 is provided with a clip 15. A head portion 15a of the clip 15 is connected to a bottom of the body 1 1 through a hinge 16, while the end portion 15b is free. The clip 15 is adapted to attach the device 10 to the publication that provides the information of the programs as well as the barcodes identifying the programs. A spring (not shown) may be provided at the hinge 16 to apply a returning force to the clip 15.

Preferably, a magnet 17 is provided at the bottom of the clip 15 so that the device 10 may be held against an external item, such as a door of a refrigerator (not shown), by a magnetic force.

Though the above has described the preferred embodiments of the present invention, it shall be understood that numerous adaptations, modifications and variations are possible to those skilled in the art without departing the gist of the present invention. For example, the electronic equipment 20 may be a TV set and the programs represented by the barcodes may be on-demand programs. Alternatively, the programs may be audio programs, and the electronic equipment 20 may be a stereo. Therefore, the scope of the present invention is solely intended to be defined by the accompanying claims.

1. A device for controlling at least one electronic equipment, comprising a scanner for reading a barcode representing formation identifying a program processable by said electronic equipment, and a remote control capable of remotely sending at least one command signal incorporating said information to said electronic equipment so as to instruct said electronic equipment to process said program.

2. The device of claim 1, wherein said means for reading comprises means for processing said read barcode to obtain said information represented by said barcode.

3. The device of claim 1, wherein said command signal is an RF signal.

4. The device of claim 1, wherein said program is an on-demand program.

5. The device of claim 1, wherein said program is a scheduled program.

6. The device of claim 1, wherein said program is a video program.

7. The device of claim 1, wherein said program is an audio program.

8. The device of claim 1, wherein said electronic equipment is a Television receiver capable of playing said program.

9. The device of claim 1, wherein said electronic equipment is a VCR capable of recording said program.

10. The device of claim 1, wherein said electronic equipment is a stereo capable of playing and/or recording said program.

11. The device of claim 1, wherein said barcode is in a print form.

12. The device of claim 11, wherein said barcode is provided in a publication of program schedules.

13. The device of claim 1, wherein said remote control is adapted to send functional commands without said information to said electronic equipment.

14. The device of claim 1, further comprising a body including said scanner and said remote control, and a clip connected to said body for attaching said device to a publication in which said barcode is printed.

15. The device of claim 14, wherein said clip comprises a first end connected to said body and a free second end.

16. The device of claim 14, further comprising a magnet adapted to hold said device to an external item by magnetic force.

17. The device of claim 16, wherein said external item is a door of a refrigerator.

18. The device of claim 1, further comprising an activation button for triggering said scanner to read said barcode.

19. The device of claim 18, wherein said remote control is adapted to automatically send said command signal upon availability of said information.

20. The device of claim 1, further comprising an activation button for triggering, with a single press, said scanner to read said barcode and then said remote control to send said command signal.

21. A print publication for providing information regarding programs processable by an electronic equipment, comprising one or more identifications each identifying one of said programs, wherein said identifications are presented as barcodes.

22. The print publication of claim 21, wherein said identifications are VCR Plus numbers.

23. The print publication of claim 21, wherein said programs are on-demand programs.

24. The print publication of claim 21, wherein said programs are scheduled programs.

25. The print publication of claim 21, wherein said electronic equipment is a TV set, a VCR or a stereo.
